(19) United States
(12) Patent Application Publication
(10) Pub. No.: US 2026/0331317 A1
(43) Pub. Date: Oct. 22, 2026

(54) REACTOR FUEL-LOADING AND REFUELING SYSTEM AND METHOD

(71) Applicant: Shanghai Nuclear Engineering Research & Design Institute Co., LTD., Shanghai (CN)

(72) Inventors: Lei LI, Shanghai (CN); Ziqiang ZHU, Shanghai (CN); Runfa LIU, Shanghai (CN); Fei MAO, Shanghai (CN); Xuefeng ZHU, Shanghai (CN); Weihua TANG, Shanghai (CN); Shaoxuan LIN, Shanghai (CN); Changlei SHAO, Shanghai (CN); Chenyang WENG, Shanghai (CN); Jianwen LIU, Shanghai (CN); Wenjun REN, Shanghai (CN); Yongjun LIU, Shanghai (CN); Wei WU, Shanghai (CN); Shangqing HUANG, Shanghai (CN); Mengzhi LI, Shanghai (CN)

(73) Assignee: Shanghai Nuclear Engineering Research & Design Institute Co., LTD., Shanghai (CN)

(21) Appl. No.: 19/113,067

(22) PCT Filed: Sep. 13, 2023
(86) PCT No.: PCT/CN2023/118445

§ 371 Date: Mar. 19, 2025

(30) Foreign Application Priority Data
Sep. 19, 2022 (CN) 202211138104.X

(51) Int. Cl. G21C 19/20; G21C 1/08; G21C 19/11; G21C 19/18; G21C 19/19; G21C 19/32

(52) U.S. Cl. CPC G21C 19/205; G21C 1/086; G21C 19/11; G21C 19/18; G21C 19/19; G21C 19/207; G21C 19/32

(57) ABSTRACT

Provided are a reactor charging and refueling system and a reactor charging and refueling method, which performs charging and refueling operations on a reactor pressure vessel having a cover capable of being opened downwards. The system comprises: a component of bolt operating device and pallet, a lifting device, an attitude adjusting device and a transfer device, wherein the component of bolt operating device and pallet, the lifting device, the attitude adjusting device and the transfer device are located underwater in a reactor core pool; the attitude adjusting device is arranged on top of the lifting device; the component of bolt operating device and pallet is connected to the attitude adjusting device; the lifting device is fixedly connected to the transfer device; and the transfer device can carry the lifting device, and the attitude adjusting device and the component of bolt operating device and pallet that are installed on the lifting device so as to be movable in a horizontal direction. With the reactor charging and refueling system and the charging and refueling method, the problems in the existing nuclear reactor refueling technology of a long path and high difficulty in disassembly and assembly are solved, thereby shortening the path and reducing the difficulty in disassembly and assembly.

### CROSS-REFERENCE TO RELATED APPLICATION

The present application claims the priority of the Chinese patent application No. 202211138104.X, filed on Sep. 19, 2022 and entitled “System and Method for Charging and Refueling a Reactor having Cover capable of being opened downwards”, which is incorporated herein by reference in its entirety.

### TECHNICAL FIELD

The present invention relates to the field of nuclear power maintenance technology, and more particularly to a reactor charging and refueling system and a reactor charging and refueling method for charging and refueling a reactor.

### BACKGROUND

A reactor charging and refueling system is a system that systematically solves the problems of opening reactor covers and replacing core fuel assemblies. In the prior art, all the charging and refueling systems for pressurized water reactors employ the manner of opening covers from the top, that is, by using a plant crane and special tools, penetration pieces on the top of the reactor and a top cover of the reactor pressure vessel are removed from the top of the reactor in sequence, then the control rod drive mechanism, the upper reactor internals and the in-reactor measurement grid are lifted out in sequence, and the replacement operations for individual fuel assemblies are carried out in sequence in the reactor.

The inventors have found that the existing refueling technology has the following shortcomings:
firstly, due to the manner of opening covers from the top in sequence for in-reactor refueling, the sequential steps for disassembling reactor components and refueling cannot be carried out in parallel, resulting a long critical path for refueling;
secondly, the disassembly and assembly of various penetration piece structures at the top of the reactor is time-consuming in the refueling path of a nuclear power plant, in particular, since the development of the third generation of pressurized water reactors, the manner of penetrating a core instrument penetration piece through the reactor pressure vessel from above has been adopted, so that the in-reactor nuclear measurement penetration pieces and core measurement instrument components to be disassembled from the top are numerous and are complex in structures, and the disassembly and assembly process is more difficult; and
thirdly, for compact reactors such as integrated reactors that have been greatly developed, due to the highly compact fully built-in layout, both the containment and the reactor pressure vessel have complex top penetration pieces, and there are compact built-in control rod drive mechanisms and heat exchange components inside the reactor, which not only increase the difficulty of opening covers from above, but also seriously restricts the feasibility of inserting the telescopic sleeve of the charging and discharging machine from above into the reactor to operate the fuel assemblies.

### SUMMARY

In view of the shortcomings of the prior art, the purpose of the present invention is to provide a reactor charging and refueling system and a reactor charging and refueling method, which overcomes the problem of long critical path resulted from the refueling manner of opening covers from above in sequence employed in the existing refueling technology, simplifies the process of the disassembly and assembly of penetration pieces at the top of reactor, lowers the difficulty, and provides a feasible implementation for opening covers and refueling in compact reactors such as integrated reactors.

A first aspect of the present invention provides a reactor charging and refueling system for performing charging and refueling operations on a reactor pressure vessel having a cover capable of being opened downwards, and comprises: a bolt operating device, which is configured to interface with a flange surface of the pressure vessel, pre-tighten and disassemble bolts connecting an upper structure and a lower structure of the pressure vessel, and be capable of bearing the disassembled lower structure of the pressure vessel; a lifting device, which is configured to lift and lower the bolt operating device loaded or unloaded with the lower structure of the pressure vessel in a vertical direction, and have a lifting stroke allowing complete separation between the lower structure and the upper structure of the pressure vessel; an attitude adjusting device, which is configured to adjust the bolt operating device so as to achieve precise interfacing between the bolt operating device and the flange surface of the pressure vessel; and a transfer device, which is configured to transfer the bolt operating device loaded or unloaded with the lower structure of the pressure vessel, the lifting device and the attitude adjusting device between a position in a reactor cavity and a transfer position of a reactor, wherein the bolt operating device, the lifting device, the attitude adjusting device and the transfer device are located underwater in a reactor core pool; the attitude adjusting device is arranged on top of the lifting device, the bolt operating device is connected to the attitude adjusting device, the lifting device is fixedly connected to the transfer device, and the transfer device is capable of carrying the lifting device, and the attitude adjusting device and the bolt operating device that are installed on the lifting device so as to be movable in a horizontal direction.

Preferably, the reactor charging and refueling system according to the present invention further includes a guiding device, which includes a plurality of mechanical guiding pairs respectively located on the bolt operating device and the pressure vessel, and is configured to provide guidance for the lifting device during a lifting process.

Preferably, the reactor charging and refueling system according to the present invention further includes a lift platform, which is arranged at the transfer position outside the reactor cavity of the reactor and is configured to lift and lower the transfer device moved to the transfer position in a vertical direction.

Preferably, the reactor charging and refueling system according to the present invention further includes a refueling stand, which is arranged underwater in a spent pool area and above the lift platform, and is configured to be capable of supporting and storing the unloaded lower structure of the pressure vessel; and a refueling machine, which is configured to perform an operation of replacing core fuel assemblies on the refueling stand.

Preferably, the reactor charging and refueling system according to the present invention further includes a hoisting tool, which is configured to hoist the lower structure of the pressure vessel stored on the refueling stand; and a bridge crane, which is connected to the hoisting tool to transfer the hoisting tool and the lower structure as a whole.

Preferably, a track is provided at bottom of the core pool and is located between bottom of the pressure vessel and the lift platform, and the transfer device is movable horizontally on the track.

Preferably, the attitude adjusting device comprises a rotating platform and a translation platform which are coaxially arranged, the rotating platform is fixedly arranged on the top of the lifting device, the translation platform is located above the rotating platform and is connected to the rotating platform through a universal ball bearing and a lead screw guide mechanism, the translation platform has a circular ring structure, and the bolt operating device is fixedly arranged on the translation platform.

Preferably, the rotating platform comprises a lower rotating unit and an upper rotating unit driven by a hydraulic cylinder, both the upper rotating unit and the lower rotating unit have circular ring structures, and the lower rotating unit and the upper rotating unit are coaxially arranged and are connected by a bearing.

Preferably, the universal ball bearing and the lead screw guide mechanism are both fixedly arranged on the upper rotating unit, the lead screw guide mechanism comprises an X-axis mechanism fixedly arranged on the upper rotating unit and a Y-axis mechanism slidably arranged on the X-axis mechanism, and the translation platform is slidably arranged on the Y-axis mechanism.

A second aspect of the present invention provides a reactor charging and refueling method, wherein charging and refueling operations on a reactor pressure vessel having a cover capable of being opened downwards are performed by using the reactor charging and refueling system according to claim 1, and the method comprises the following steps:
moving the transfer device to the position in the reactor cavity right below the reactor;
lifting the bolt operating device by the lifting device, so that the bolt operating device approaches the flange surface of the pressure vessel from below;
adjusting a position, levelness and radial azimuth of the bolt operating device by the attitude adjusting device to achieve interfacing with the flange surface of the reactor pressure vessel;
removing and retrieving bolts connecting the upper structure and the lower structure of the pressure vessel by the bolt operating device;
carrying the bolt operating device loaded with the lower structure of the pressure vessel to descend by the lifting device; and
transferring the bolt operating device loaded or unloaded with the lower structure of the pressure vessel, the lifting device and the attitude adjusting device by the transfer device between the position in the reactor cavity and the transfer position.

In the present invention, by employing a reactor charging and refueling system implemented with a cover capable of being opened downwards, after cover opening and transferring of the reactor, the replacement operations of core fuel assemblies can be carried out in a tight sequence, which can separate a series of operations of opening covers in sequence from the top from the critical path of refueling compared with the existing refueling technology for pressurized water reactors. Even if the upper components of the reactor need to be further disassembled due to in-service inspection, etc., the disassembly operations can be carried out simultaneously with the subsequent replacement operation of core fuel assemblies, thereby shortening the overhaul path and improving the economic efficiency of operation and maintenance of power plants. At the same time, the refueling manner implemented with the cover capable of being opened downwards can overcome the problem of disassembly and assembly of the complex penetration pieces on the top of the reactor, which is beneficial to the third-generation pressurized water reactors and compact small reactors, for which the disassembly and assembly operations of the penetration pieces on the top of the reactor are difficult to be implemented.

In the present invention, by employing a refueling manner implemented with a cover capable of being opened downwards, after the lower structure of the reactor pressure vessel is transferred as a whole, open refueling can be carried out above the core, which greatly reduces the difficulty of replacement operation of the core fuel assemblies, and is beneficial to compact reactors such as integrated reactors with compact and narrow in-reactor space, for which the refueling operation in traditional methods are difficult to be carried out.

It should be understood that the above general description and the following detailed description are exemplary only and do not limit the present application.

### BRIEF DESCRIPTION OF THE DRAWINGS

In order to illustrate the technical solutions of the embodiments of the present application more clearly, the accompanying drawing that needs to be used in the embodiments of the present application will be briefly introduced below.

FIG. 1 is a schematic diagram of a first state (the transfer device runs to the position in the reactor cavity) of performing refueling for a pressurized water reactor according to one or more implementations of the present invention;

FIG. 2 is a schematic diagram of a second state (the lifting of the lifting device is in place) of performing refueling for a pressurized water reactor according to one or more implementations of the present invention;

FIG. 3 is a schematic diagram of a third state (the adjusting of the attitude adjusting device is in place to achieve flange interfacing) of performing refueling for a pressurized water reactor according to one or more implementations of the present invention;

FIG. 4 is a schematic diagram of a fourth state (the bolt operating device implements flange surface disassembly) of performing refueling for a pressurized water reactor according to one or more implementations of the present invention;

FIG. 5 is a schematic diagram of a fifth state (the lifting device descends) of performing refueling for a pressurized water reactor according to one or more implementations of the present invention;

FIG. 6 is a schematic diagram of a sixth state (the transfer device runs to the transfer position) of performing refueling for a pressurized water reactor according to one or more implementations of the present invention;

FIG. 7 is a schematic diagram of a seventh state (the lower structure of the reactor pressure vessel is hoisted onto the refueling stand) of performing refueling for a pressurized water reactor according to one or more implementations of the present invention;

FIG. 8 is a schematic diagram of an eighth state (the core is refueled) of performing refueling for a pressurized water reactor according to one or more implementations of the present invention;

FIG. 9 is a schematic diagram of a ninth state (the lower structure of the reactor pressure vessel is reinstalled) of performing refueling for a pressurized water reactor according to one or more implementations of the present invention;

FIG. 10 is a schematic diagram of a tenth state (the transfer trolley is lifted to the operating platform by the lift platform) of performing refueling for a pressurized water reactor according to one or more implementations of the present invention;

FIG. 11 is a schematic structural diagram of the front view of the attitude adjusting device according to one or more implementations of the present invention; and

FIG. 12 is an A-A view of FIG. 11.

### REFERENCE NUMERALS

100—Reactor charging and refueling system;
1—Bolt operating device;
101—Pallet;
2—Lifting device;
3—Attitude adjusting device;
31—Lower rotating unit;
32—Upper rotating unit;
33—Hydraulic cylinder;
34—Universal ball bearing;
35—Translation platform;
36—Lead screw guide mechanism;
361—X-axis mechanism;
362—Y-axis mechanism;
37—Rotating platform;
4—Transfer device;
41—Track;
5—Guide device;
51—Guide seat;
52—Guide shaft;
6—Lift platform;
7—Refueling stand;
8—Pressure vessel;
82—Lower structure;
83—Bolt;
84—Flange surface;
9—Core hanging basket;
10—Refueling machine;
11—Hoisting tool;
12—Bridge crane.

### DETAILED DESCRIPTION

In order to better understand the technical solutions of the present application, the embodiments of the present application will be described in detail below in conjunction with the accompanying drawings.

The existing manner of opening covers from the top in sequence to carry out the in-reactor refueling has the problems that the critical path for refueling is long, the in-reactor nuclear measurement penetration pieces and core measurement instrument components to be disassembled from the top are numerous and are complex in structures, and the disassembly and assembly process is more difficult. In order to solve the above technical problems, the present invention proposes a reactor charging and refueling system and method.

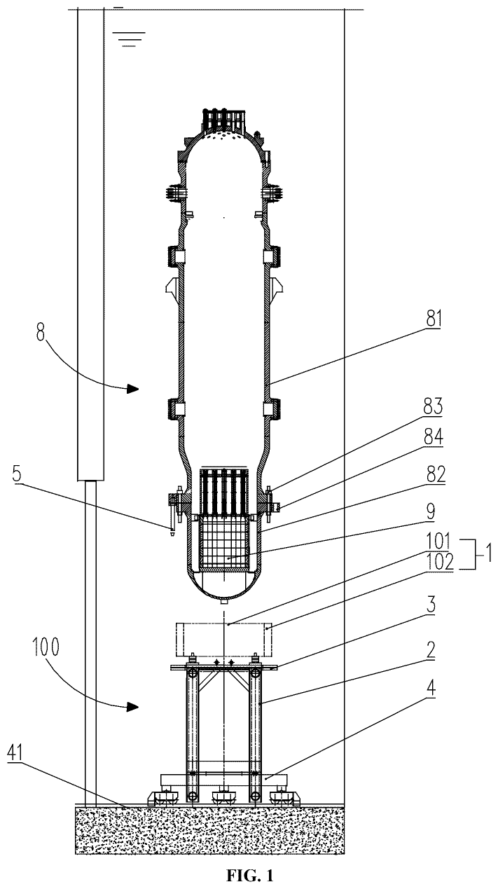

FIG. 1 is a schematic diagram of a first state (the transfer device runs to the position in the reactor cavity) of performing refueling for a pressurized water reactor according to one or more implementations of the present invention.

As shown in FIG. 1, the reactor charging and refueling system 100 of this embodiment performs charging and refueling operations on a reactor pressure vessel 8 having a cover capable of being opened downwards, and includes a bolt operating device 1, a lifting device 2, an attitude adjusting device 3 and a transfer device 4.

The reactor pressure vessel 8 having the cover capable of being opened downwards is a pressure vessel having a refueling flange and reactor internals. That is, the reactor pressure vessel 8 comprises a vessel shell and internals (in order to explain the main points of the present invention in detail, internals irrelevant to the present invention are not shown in FIG. 1 and other figures), wherein the vessel shell comprises an upper shell and a lower shell. The portion of the vessel located above the refueling flange is the upper shell, which can be connected through its own structure, and the upper shell as well as the control rod drive mechanism, upper reactor internals, and in-reactor measurement grid (not shown) in the upper shell together constitute an integrated upper structure 81. The portion of the vessel located below the refueling flange is the lower shell, and the lower shell as well as the core hanging basket 9 and the core carried on the lower shell together form a lower structure 82. The upper structure 81 and the lower structure 82 are connected by bolts 83.

The core hanging basket 9 has a hanging basket structure with an integral frame containing the core, is used to realize the overall hoisting of the core and the off-reactor refueling, and is in a structure capable of accommodating all the fuel assemblies of the core and performing overall lifting.

The bolt operating device 1 is used to interface with the flange surface 84 of the pressure vessel 8, pre-tighten and disassemble the bolts 83 connecting the upper structure 81 and the lower structure 82 of the pressure vessel 8, and can support the disassembled lower structure 82 of the pressure vessel 8.

The bolt operating device 1 includes a pallet 101, a plurality of independent automatic bolt disassembly and assembly mechanisms and a plurality of independent automatic bolt pre-tightening mechanisms. The pallet 101 is fixedly arranged on the attitude adjusting device 3 through a bracket, and can interface with the lower edge of the flange surface 84 of the reactor pressure vessel 8 and bear the weight of the lower structure 82 of the reactor pressure vessel 8 during a lifting process. When the pallet 101 accurately interfaces with the lower edge of the flange surface 84 of the reactor pressure vessel, the automatic bolt disassembly and assembly mechanism and the automatic bolt pre-tightening mechanism can be used to implement automatic disassembly/assembly of the bolts.

The automatic bolt pre-tightening mechanism can adaptively engage with the bolt 83, and complete the pre-tightening of the bolt 83, the extension measurement and the rotation of a nut. The automatic bolt disassembly and assembly mechanism includes several multi-degree-of-freedom automatic mechanical arms, related instruments and sensors, etc., can automatically disassemble or assemble bolts and nuts, and place them in a temporary storage structure.

It can be understood that the automatic bolt pre-tightening mechanism and the automatic bolt disassembly and assembly mechanism are both existing technical means, and no repeated description will be given herein.

The lifting device 2 is a lifting device with several levels of hydraulic cylinder lifting structures. The lifting device 2 is used to lift and lower the bolt operating device 1 loaded or unloaded with the lower structure 82 of the pressure vessel 8 in the vertical direction, and has a lifting stroke allowing the complete separation or interfacing between the lower structure 82 and the upper structure 81 of the pressure vessel 8.

The attitude adjusting device 3 is used to adjust the bolt operating device 1 so as to achieve precise interfacing between the bolt operating device 1 and the flange surface 84 of the pressure vessel 8.

The attitude adjusting device 3 is fixedly arranged on the top of the lifting device 2, has execution capability in multi-degree-of-freedom such as position, levelness and radial azimuth, and is used for adjusting a terminal attitude in the lifting stage, so as to achieve precise interfacing between the bolt operating device 1 and the lower edge of the flange surface 84 of the reactor pressure vessel 8.

The transfer device 4 is used to transfer the bolt operating device 1 loaded or unloaded with the lower structure 82 of the pressure vessel 8, the lifting device 2 and the attitude adjusting device 3 between a position in the reactor cavity and a transfer position of the reactor.

The transfer device 4 is located underwater in the core pool and below the reactor pressure vessel 8. The transfer device 4 is a transfer trolley that can achieve horizontal movement. Specifically, in this embodiment, the transfer device 4 is in a trolley structure that runs horizontally on a track 41. The track 41 is arranged at the bottom of the core pool and is located below the reactor pressure vessel 8. The trolley is driven by a wire rope or in a hydraulic manner to transfer the bolt operating device 1 loaded or unloaded with the lower structure 82 of the pressure vessel 8 between the transfer position and the position in the reactor cavity.

The bolt operating device 1, the lifting device 2, the attitude adjusting device 3 and the transfer device 4 are located underwater in the reactor core pool. The attitude adjusting device 3 is arranged on the top of the lifting device 2. The bolt operating device 1 is connected to the attitude adjusting device 3. The lifting device 2 is fixedly connected to the transfer device 4. The transfer device 4 can drive the lifting device 2, and the attitude adjusting device 3 and the bolt operating device 1 that are installed on the lifting device 2 to move in the horizontal direction.

As shown in FIG. 1, at the beginning of refueling, the water level of the refueling pool is maintained at a refueling water level, the driving cables, pipelines, etc. of the bolt operating device 1, the transfer device 4, the lifting device 2 and the attitude adjusting device 3 are connected, and the lifting device 2 and the bolt operating device 1 are transferred through the transfer device 4 from the transfer position to the position in the reactor cavity right below the reactor.

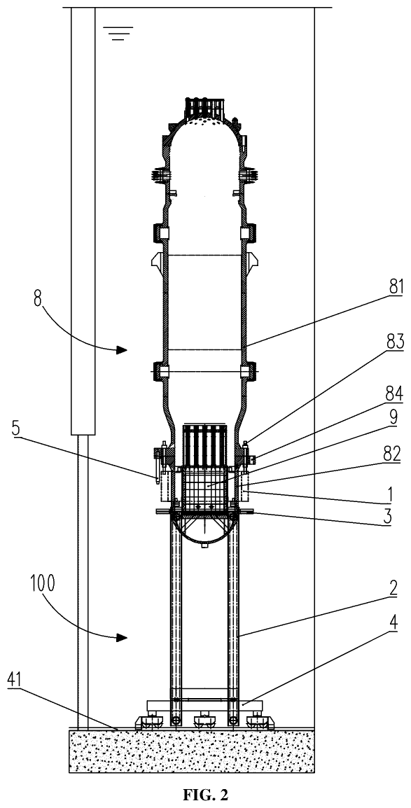

FIG. 2 is a schematic diagram of a second state (the lifting of the lifting device is in place) of performing refueling for a pressurized water reactor according to one or more implementations of the present invention.

As shown in FIG. 2, the reactor charging and refueling system 100 of the present invention further includes a guide device 5, which includes a plurality of mechanical guide pairs respectively located on the bolt operating device 1 and the pressure vessel 8, and can provide guidance for the lifting device 2 during the lifting process.

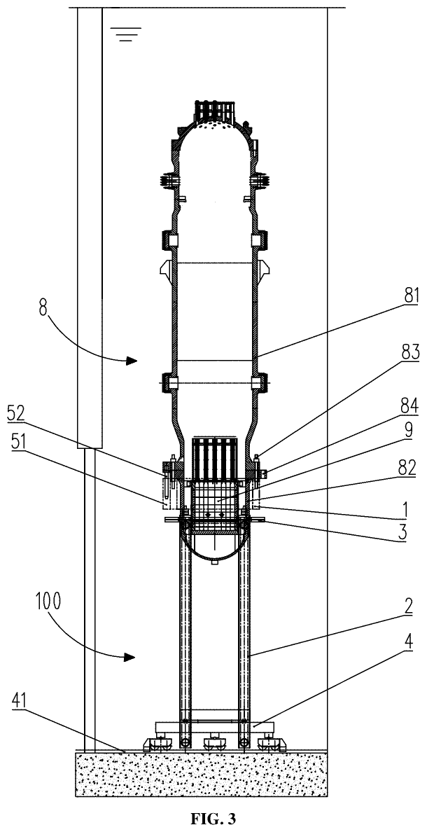

Specifically, the guide device 5 includes: a guide seat 51, which has a guide groove and is fixed on the pallet 101; and a guide shaft 52, which is fixed at a corresponding position on the lower end of the reactor pressure vessel 8 above the refueling flange. The guide shaft 52 can be inserted into the guide seat 51 (see FIG. 3) to provide a centering guidance for the pallet 101 during the process of opening and closing the cover of the reactor pressure vessel 8, so as to ensure the centering accuracy of the upper and lower parts of the reactor pressure vessel 8 during the process of opening and closing covers.

As shown in FIG. 2, the lifting device 2 lifts the bolt operating device 1 to approach the flange surface 84 of the reactor pressure vessel from below and enter the guide stroke of the guide device 5. At this time, the guide shaft 52 at the lower end of the pressure vessel 8 has not yet cooperated with the guide seat 51 on the pallet 101.

FIG. 3 is a schematic diagram of a third state (the adjusting of the attitude adjusting device is in place to achieve flange interfacing) of performing refueling for a pressurized water reactor according to one or more implementations of the present invention.

As shown in FIG. 3, the position, levelness and radial azimuth in the terminal attitude of the bolt operating device 1 are adjusted by the attitude adjusting device 3 to achieve interfacing with the flange surface 84 of the reactor pressure vessel. At this time, the guide shaft 52 at the lower end of the pressure vessel 8 cooperates with the guide seat 51 on the pallet 101 to achieve a guidance.

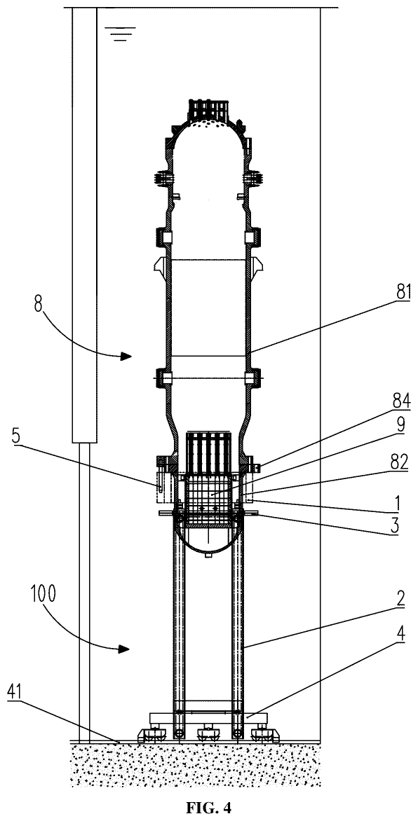

FIG. 4 is a schematic diagram of a fourth state (the bolt operating device implements flange surface disassembly) of performing refueling for a pressurized water reactor according to one or more implementations of the present invention.

As shown in FIG. 4, the bolt operating device 1 removes and retrieves flange nuts and bolts 83 of the reactor pressure vessel. In this state, the removal of all bolts 83 has been completed.

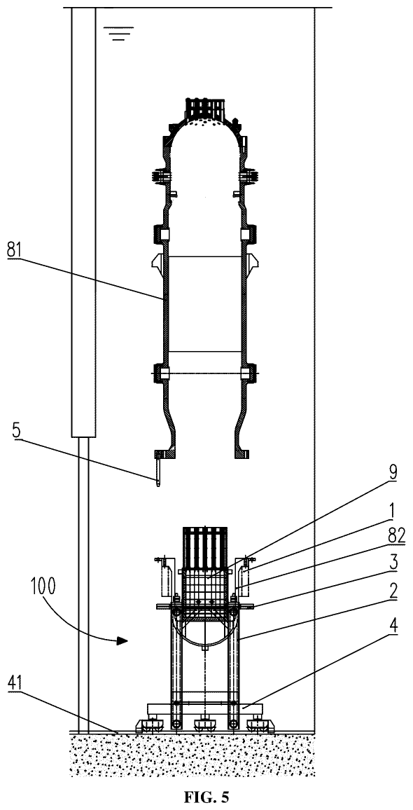

FIG. 5 is a schematic diagram of a fifth state (the lifting device descends) of performing refueling for a pressurized water reactor according to one or more implementations of the present invention.

As shown in FIG. 5, the lifting device 2 carries the bolt operating device 1 to descend, and thus carries the lower structure 82 of the reactor pressure vessel 8 including the core hanging basket 9 to descend, until the lifting device 2 is in a fully retracted state. In this state, the transfer device 4 can prepare to transfer the lower structure 82 to the transfer position.

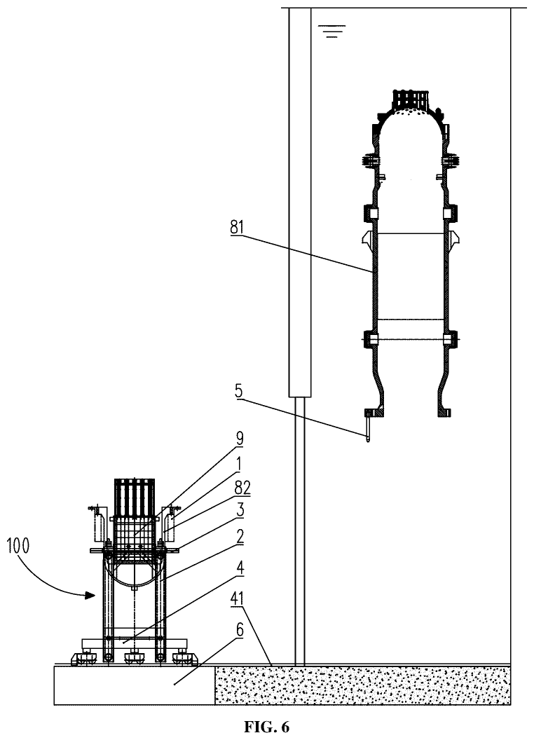

FIG. 6 is a schematic diagram of a sixth state (the transfer device runs to the transfer position) of performing refueling for a pressurized water reactor according to one or more implementations of the present invention.

As shown in FIG. 6, the transfer device 4 transfers the lifting device 2 from the position in the reactor cavity to the transfer position outside the reactor cavity. A lift platform 6 is provided below the transfer position to lift and lower the transfer device 4 moved to the transfer position in the vertical direction. The lift platform 6 is a platform-type lift that performs lifting and lowering operations in the underwater vertical direction, and can lift and lower the transfer device 4 loaded or unloaded with the lower structure 82 of the reactor pressure vessel. In the state shown in FIG. 6, the transfer device 4 has transferred the lower structure 82 to the lift platform 6 at the transfer position, and at this time, the lift platform 6 can perform lifting and lowering operations.

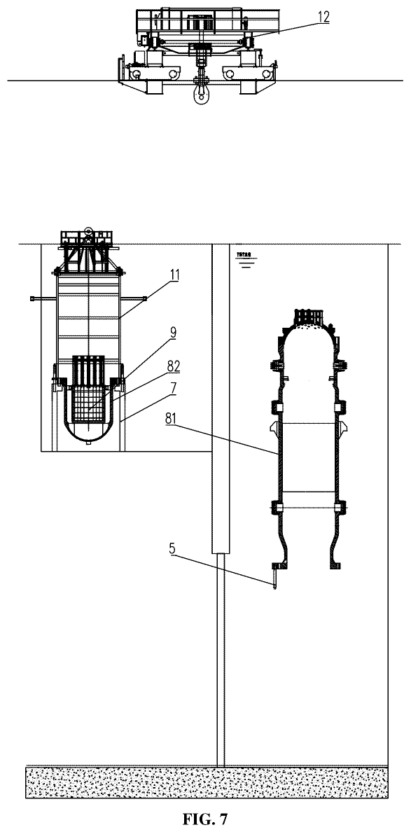

FIG. 7 is a schematic diagram of a seventh state (the lower structure of the reactor pressure vessel is hoisted onto the refueling stand) of performing refueling for a pressurized water reactor according to one or more implementations of the present invention.

As shown in FIG. 7, the reactor charging and refueling system 100 of the present invention further includes the refueling stand 7, which is disposed underwater in the spent pool area and above the lift platform 6, and is capable of supporting and storing the unloaded lower structure 82 of the pressure vessel 8.

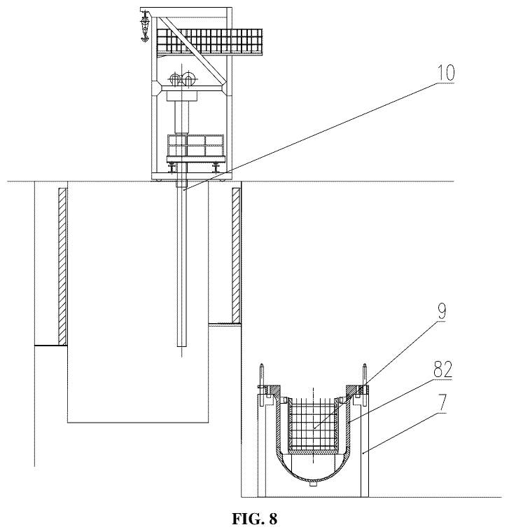

The refueling stand 7 is close to the lift platform 6. The refueling stand 7 is a stand structure and is located underwater in the spent pool area for supporting and storing the unloaded lower structure of the reactor pressure vessel, and allows the refueling machine 10 (see FIG. 8) to perform replacement operations on core fuel assemblies at this location. In this embodiment, the refueling stand 7 has a special storage rack structure with a support ring and guide pins.

The reactor charging and refueling system 100 further includes a hoisting tool 11, which is capable of hoisting the lower structure 82 of the pressure vessel 8 stored on the refueling stand 7.

The reactor charging and refueling system 100 further includes a bridge crane 12, which is connected to the hoisting tool 11 to transfer the hoisting tool 11 and the lower structure 82 as a whole.

The hoisting tool 11 has the ability to hoist the lower structure 82 of the reactor pressure vessel. The bridge crane 12 is arranged in a refueling operation hall in the spent pool area, is a heavy-loaded double-beam bridge crane with high positioning accuracy, and is used to hoist the lower structure 82 of the reactor pressure vessel through the hoisting tool 11 during the reactor charging and refueling.

As shown in FIG. 7, the lift platform 6 carries the transfer device 4 to lift it to a height where the hoisting tool 11 can perform hoisting, and ensures that the fuel assemblies therein have a sufficient shielding water layer. The lower structure of the reactor pressure vessel including the core hanging basket 9 is hoisted onto the refueling stand 7 by the bridge crane 12 and the hoisting tool 11.

FIG. 8 is a schematic diagram of an eighth state (the core is refueled) of performing refueling for a pressurized water reactor according to one or more implementations of the present invention.

As shown in FIG. 8, the reactor charging and refueling system 100 further includes a refueling machine 10, which performs the replacement operation of the core fuel assemblies on the refueling stand 7.

The refueling machine 10 is a bridge crane capable of operating fuel assemblies and inserts outside the reactor and in the spent pool area. The refueling machine 10 is provided with a telescopic sleeve and special operating grippers for fuel assemblies and inserts.

It can be understood that the refueling machine 10, the hoisting tool 11 and the bridge crane 12 are all in existing structures, and the specific structural forms are not described in detail here.

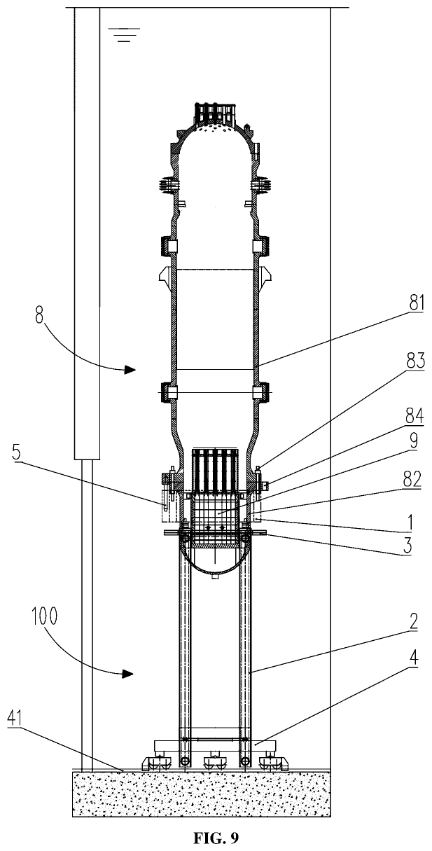

FIG. 9 is a schematic diagram of a ninth state (the lower structure of the reactor pressure vessel is reinstalled) of performing refueling for a pressurized water reactor according to one or more implementations of the present invention.

As shown in FIG. 9, after the replacement for the core is completed, the lower structure 82 of the reactor pressure vessel including the core hanging basket 9 on the refueling stand 7 is hoisted onto the pallet 101 by the bridge crane 2 and the hoisting tool 11, the lift platform 6 carries the transfer device 4 to descend, the transfer device 4 transfers the lifting device 2 from the lift platform 6 located at the transfer position to the position in the reactor cavity, and the lifting device 2 lifts the bolt operating device to approach the flange surface of the reactor pressure vessel from below and enter the guide stroke of the guide device 5. The position, levelness and radial azimuth in the terminal attitude of the bolt operating device 1 are adjusted by the attitude adjusting device 3 to achieve interfacing with the flange surface 84 of the reactor pressure vessel, and the bolt operating device 1 installs the flange nuts and bolts 83 of the reactor pressure vessel, so as to reinstall the lower structure 82 of the reactor pressure vessel.

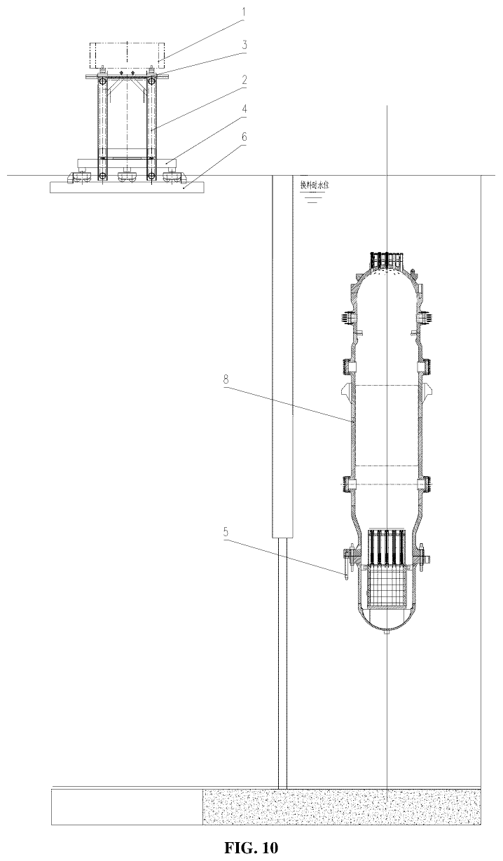

FIG. 10 is a schematic diagram of a tenth state (the transfer trolley is lifted to the operating platform by the lift platform) of performing refueling for a pressurized water reactor according to one or more implementations of the present invention.

As shown in FIG. 10, the transfer device 4 is moved back to the lift platform 6 located at the transfer position, is lifted to the operating platform above the water surface by the lift platform 6, and can be moved out of the nuclear power plant for storage and maintenance.

Due to employing a refueling manner implemented with a cover capable of being opened downwards, after the lower structure 82 of the reactor pressure vessel is transferred as a whole, open refueling can be carried out above the core, which greatly reduces the difficulty of replacement operation of the core fuel assemblies, and is especially beneficial to compact reactors such as integrated reactors with compact and narrow in-reactor space, for which the refueling operation in traditional methods are difficult to be carried out.

By employing the refueling manner implemented with a cover capable of being opened downwards, after cover opening and transferring of the reactor, the replacement operations of core fuel assemblies can be carried out in a tight sequence, which can separate a series of operations of opening covers in sequence from the top from the critical path of refueling compared with the existing refueling technology for pressurized water reactors. Even if the upper components of the reactor need to be further disassembled due to in-service inspection, etc., the disassembly operations can be carried out simultaneously with the subsequent replacement operation of core fuel assemblies, thereby shortening the overhaul path and improving the economic efficiency of operation and maintenance of power plants. At the same time, the refueling manner implemented with the cover capable of being opened downwards can overcome the problem of disassembly and assembly of the complex penetration pieces on the top of the reactor, which is especially beneficial to the third-generation pressurized water reactors and compact small reactors, for which the disassembly and assembly operations of the penetration pieces on the top of the reactor are difficult to be implemented.

FIG. 11 is a schematic structural diagram of the front view of the attitude adjusting device according to one or more implementations of the present invention.

As shown in FIG. 11, the attitude adjusting device 3 comprises a rotating platform 37 and a translation platform 35. The rotating platform 37 is fixedly arranged on the top of the lifting device 3, and the translation platform 35 is located above the rotating platform. The translation platform 35 is connected to the rotating platform through a universal ball bearing 34 and a lead screw guide mechanism 36.

The translation platform 35 has a circular ring structure, and the bolt operating device 1 is fixedly arranged on the translation platform 35.

The rotating platform 37 comprises a lower rotating unit 31 and an upper rotating unit 32 driven by a hydraulic cylinder 33. The upper rotating unit 32 and the lower rotating unit 31 are both in circular ring structures. The lower rotating unit 31 and the upper rotating unit 32 are coaxially arranged and are connected by a bearing (such as a plane bearing, etc.).

Sides of the upper rotating unit 32 and the lower rotating unit 31 are provided with outward protrusions, and the protrusions on the same sides of the lower rotating unit 31 and the upper rotating unit 32 are connected through the hydraulic cylinder 33 therebetween. The hydraulic cylinder 33 is a bidirectional hydraulic cylinder and is hinged to the protrusions at both ends thereof, so that the upper rotating unit 32 is driven to rotate by telescoping of the hydraulic cylinder 33.

It can be understood that at least one hydraulic cylinder 33 is provided. When two hydraulic cylinders 33 are provided, the two hydraulic cylinders 33 should be oppositely arranged on two sides of the rotating platform 37, and the rotating platform 37 can be driven to rotate by performing opposite telescopic movements, so as to improve the rotation ability of the rotating platform 37.

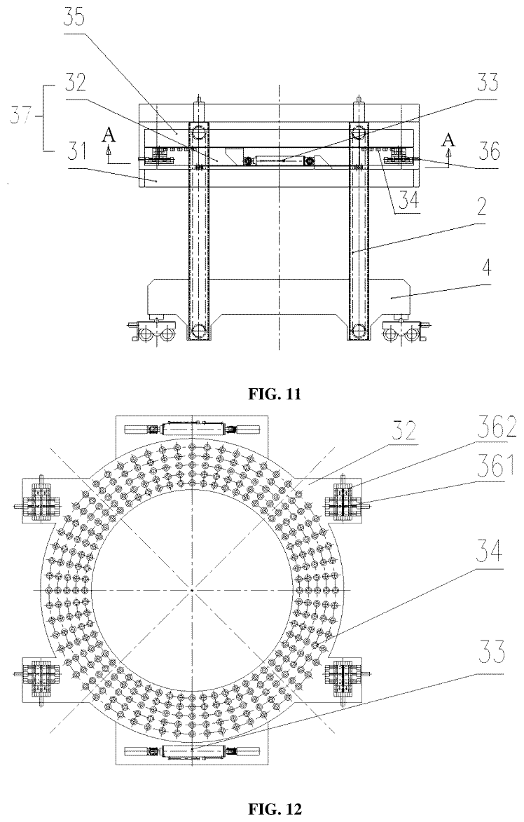

FIG. 12 is an A-A view of FIG. 11.

As shown in FIG. 12, the universal ball bearing 34 and the lead screw guide mechanism 36 are both fixedly arranged on the upper rotating unit. The lead screw guide mechanism 36 comprises an X-axis mechanism 361 fixedly arranged on the upper rotating unit 32 and a Y-axis mechanism 362 slidably arranged on the X-axis mechanism 361, and the translation platform 35 is slidably arranged on the Y-axis mechanism.

Several universal ball bearings 34 are evenly fixed on the upper surface of the upper rotating unit 32, and the vertical loads of the translation platform 35 and parts above it are supported by the universal ball bearings 34. The lead screw guide mechanism 36 is further fixedly arranged on the upper rotating unit 32, and the lead screw guide mechanism 36 comprises two layers: the X-axis mechanism 361 and the Y-axis mechanism 362, wherein the X-axis mechanism is fixedly arranged on the upper rotating unit 32, the Y-axis mechanism 362 is slidably arranged on the X-axis mechanism 361, and the two mechanisms are arranged perpendicular to each other. The Y-axis mechanism 362 is driven by the lead screw on the X-axis mechanism 361, a base is slidably arranged on the Y-axis mechanism 362 and is driven by the lead screw on the Y-axis mechanism 362. The translation platform 35 is fixedly arranged on the base, and the pallet 101 is fixedly arranged on the translation platform 35.

The translation platform 35 has a circular ring structure, the translation platform 35 and the rotating platform 37 are coaxially arranged. The coaxial arrangement serves as the installation reference, and can effectively ensure the accuracy of the subsequent attitude adjustment.

It can be understood that there may be one or more lead screw guide mechanisms 36, and the specific number thereof may be selected according to actual needs, and no excessive restrictions are made here.

The attitude adjusting device 3 has the ability of adjustment in multi-degree-of-freedom such as position, levelness and radial azimuth, and is used for slight adjustment of the terminal attitude in the lifting stage, so as to achieve precise interfacing between the pallet 101 and the lower edge of the flange surface of the reactor pressure vessel.

A second aspect of the present invention provides a reactor charging and refueling method, in which charging and refueling operations on the reactor pressure vessel 8 having a cover capable of being opened downwards are performed by using the reactor charging and refueling system as described above. The method includes the following steps:
the transfer device 4 is moved to the position in the reactor cavity right below the reactor;
the bolt operating device 1 is lifted by the lifting device 2, so that the bolt operating device 1 approaches the flange surface 84 of the pressure vessel from below;
the attitude adjusting device 3 adjusts the position, levelness and radial azimuth in the attitude of the bolt operating device 1 to achieve interfacing with the flange surface 84 of the reactor pressure vessel;
the bolt operating device 1 is used to remove and retrieve the bolts 83 connecting the upper structure 81 and the lower structure 82 of the pressure vessel 8;
the lifting device 2 is used to carry the bolt operating device 1 loaded with the lower structure 82 of the pressure vessel 8 to descend;
the bolt operating device 1 loaded or unloaded with the lower structure 82 of the pressure vessel 8, the lifting device 2 and the attitude adjusting device 3 are transferred between the position in the reactor cavity and the transfer position 4 through the transfer device 4;
the transfer device 4 transfers the lower structure 82 to the lift platform 6 at the transfer position, and the lift platform 6 carries the transfer device 4, lifts it to a height where the hoisting tool 11 can perform hoisting, and ensures that the fuel assemblies therein have a sufficient shielding water layer; the lower structure of the reactor pressure vessel including the core hanging basket 9 is hoisted to the refueling stand 7 by the bridge crane 12 and the hoisting tool 11; and the refueling machine 10 performs the replacement operation of the core fuel assemblies on the refueling stand 7.

After the replacement for the core is completed, the lower structure 82 of the reactor pressure vessel including the core hanging basket 9 on the refueling stand 7 is hoisted onto the pallet 101 by the bridge crane 2 and the hoisting tool 11, the lift platform 6 carries the transfer device 4 to descend, the transfer device 4 transfers the lifting device 2 from the lift platform 6 located at the transfer position to the position in the reactor cavity, and the lifting device 2 lifts the bolt operating device to approach the flange surface of the reactor pressure vessel from below and enter the guide stroke of the guide device 5. The position, levelness and radial azimuth in the terminal attitude of the bolt operating device 1 are adjusted by the attitude adjusting device 3 to achieve interfacing with the flange surface 84 of the reactor pressure vessel, and the bolt operating device 1 installs the flange nuts and bolts 83 of the reactor pressure vessel, so as to reinstall the lower structure 82 of the reactor pressure vessel.

The transfer device 4 is moved back to the lift platform 6 at the transfer position, is lifted to the operating platform above the water surface by the lift platform 6, and can be moved out of the nuclear power plant for storage and maintenance.

The above is only the preferred embodiment of the present application, and is not intended to limit the application. For those skilled in the art, the present application may have various changes and variations. Any modification, equivalent replacement, improvement, etc. made within the spirit and principle of the application should be included in the protection scope of the present application.

1. A reactor charging and refueling system for performing charging and refueling operations on a reactor pressure vessel having a cover capable of being opened downwards, the system comprising:
a component of bolt operating device and pallet comprising a bolt operating device and a pallet, wherein the pallet is configured to interface with a flange surface of the pressure vessel and be capable of bearing the disassembled lower structure of the pressure vessel, and the bolt operating device is configured to pre-tighten and disassemble bolts connecting an upper structure and a lower structure of the pressure vessel;
a lifting device, which is configured to lift and lower the component of bolt operating device and pallet loaded or unloaded with the lower structure of the pressure vessel in a vertical direction, and have a lifting stroke allowing complete separation between the lower structure and the upper structure of the pressure vessel;
an attitude adjusting device, which is configured to adjust the bolt operating device so as to achieve precise interfacing between the bolt operating device and the flange surface of the pressure vessel; and
a transfer device, which is configured to transfer the component of bolt operating device and pallet loaded or unloaded with the lower structure of the pressure vessel, the lifting device and the attitude adjusting device between a position in a reactor cavity and a transfer position of a reactor,
wherein the component of bolt operating device and pallet, the lifting device, the attitude adjusting device and the transfer device are located underwater in a reactor core pool; the attitude adjusting device is arranged on top of the lifting device, the component of bolt operating device and pallet is connected to the attitude adjusting device, the lifting device is fixedly connected to the transfer device, and the transfer device is capable of carrying the lifting device, and the attitude adjusting device and the component of bolt operating device and pallet that are installed on the lifting device so as to be movable in a horizontal direction.

2. The reactor charging and refueling system according to claim 1, further comprising: a guiding device, which comprises a plurality of mechanical guiding pairs respectively located on the pallet and the pressure vessel, and is configured to provide guidance for the pallet during a process of opening and closing the cover of the reactor pressure vessel.

3. The reactor charging and refueling system according to claim 1, further comprising: a lift platform, which is arranged at the transfer position outside the reactor cavity of the reactor and is configured to lift and lower the transfer device moved to the transfer position in a vertical direction.

4. The reactor charging and refueling system according to claim 3, further comprising: a refueling stand, which is arranged underwater in a spent pool area and above the lift platform, and is configured to be capable of supporting and storing the unloaded lower structure of the pressure vessel; and a refueling machine, which is configured to perform an operation of replacing core fuel assemblies on the refueling stand.

5. The reactor charging and refueling system according to claim 4, further comprising: a hoisting tool, which is configured to hoist the lower structure of the pressure vessel stored on the refueling stand; and a bridge crane, which is connected to the hoisting tool to transfer the hoisting tool and the lower structure as a whole.

6. The reactor charging and refueling system according to claim 3, wherein a track is provided at bottom of the core pool and is located between bottom of the pressure vessel and the lift platform, and the transfer device is movable horizontally on the track.

7. The reactor charging and refueling system according to claim 1, wherein the attitude adjusting device is composed of a rotating platform and a translation platform which are coaxially arranged, the rotating platform is fixedly arranged on the top of the lifting device, the translation platform is located above the rotating platform and is connected to the rotating platform through a universal ball bearing and a lead screw guide mechanism, the translation platform has a circular ring structure, and the component of bolt operating device and pallet is fixedly arranged on the translation platform.

8. The reactor charging and refueling system according to claim 7, wherein the rotating platform comprises a lower rotating unit and an upper rotating unit driven by a hydraulic cylinder, both the upper rotating unit and the lower rotating unit have circular ring structures, and the lower rotating unit and the upper rotating unit are coaxially arranged and are connected by a bearing.

9. The reactor charging and refueling system according to claim 8, wherein the universal ball bearing and the lead screw guide mechanism are both fixedly arranged on the upper rotating unit, the lead screw guide mechanism comprises an X-axis mechanism fixedly arranged on the upper rotating unit and a Y-axis mechanism slidably arranged on the X-axis mechanism, and the translation platform is slidably arranged on the Y-axis mechanism.

10. A reactor charging and refueling method, wherein charging and refueling operations on a reactor pressure vessel having a cover capable of being opened downwards are performed by using the reactor charging and refueling system according to claim 1, the method comprises the following steps:
moving the transfer device to the position in the reactor cavity right below the reactor;
lifting the component of bolt operating device and pallet by the lifting device, so that the component of bolt operating device and pallet approaches the flange surface of the pressure vessel from below;
adjusting a position, levelness and radial azimuth of the component of bolt operating device and pallet by the attitude adjusting device to achieve interfacing with the flange surface of the reactor pressure vessel;
removing and retrieving bolts connecting the upper structure and the lower structure of the pressure vessel by the bolt operating device;
carrying the component of bolt operating device and pallet loaded with the lower structure of the pressure vessel to descend by the lifting device; and
transferring the component of bolt operating device and pallet loaded with the lower structure of the pressure vessel, the lifting device and the attitude adjusting device by the transfer device between the position in the reactor cavity and the transfer position.
